(19) United States
(12) Patent Application Publication
(10) Pub. No.: US 2026/0285646 A1
(43) Pub. Date: Sep. 24, 2026

(54) STEP ELEMENT FOR A SYSTEM FOR CONVEYING PEOPLE, AND PRESSURE DIE-CASTING TOOL FOR A STEP ELEMENT

(71) Applicant: INVENTIO AG, Hergiswil (CH)

(72) Inventor: Martin Brestensky, Pitten (AT)

(21) Appl. No.: 19/469,976

(22) PCT Filed: May 13, 2024
(86) PCT No.: PCT/EP2024/063084

§ 371 Date: Sep. 26, 2025

(30) Foreign Application Priority Data
May 24, 2023 (EP) 23174991.2

(51) Int. Cl. B66B 23/12; B22D 17/22

(52) U.S. Cl. CPC B66B 23/12; B22D 17/2245

(57) ABSTRACT

The present invention relates to a step element for a system for conveying people, wherein the step element has a rib structure on a tread surface made of die-cast metal and has a corrugated structure on a rear side of the tread surface, wherein a corrugation trough of the corrugated structure is arranged in each case opposite a tread rib of the rib structure in order to save metal material in the region of a rib foot of the tread rib, wherein at least one portion of the corrugated structure has arranged thereon an impression of a turbulence structure which is formed in a pressure die-casting tool for the step element and which serves to generate a turbulent flow when casting the step element, wherein the impression projects from the corrugated structure and substantially represents a contour of the corrugated structure.

The present invention relates to a step element for a system for conveying people which is designed as an escalator or moving walkway, and to a pressure die-casting tool for producing such a step element.

A system for conveying people designed as an escalator or moving walkway can have a circumferentially arranged step belt made up of step elements arranged one behind the other and connected to one another in an articulated manner, which are arranged close together in a row at least on an upper side of the system for conveying people and form a walkable tread surface of the system for conveying people.

The step elements can consist of die-cast metal (in particular aluminum die-cast products made of light metal alloys, the main alloy component of which is aluminum) and can be manufactured in a pressure die-casting tool (die-cast mold). In order to need as little metal material as possible, the wall thicknesses of the step elements can be optimized. However, during the production of step elements, it has been shown that narrow channels in the pressure die-casting tool strongly direct the flow of the liquid metal within a pressure die-casting tool and thereby cause alloy components to separate from the melt and settle locally in undesirable concentrations. These concentrations can lead to local weakening in the solidified step element so that this sets limits to the reduction or optimization of wall thicknesses.

For example, WO 2009/010495 A2 describes a step element for a conveyor. Furthermore, WO 2019/048306 A1 describes a step unit for a system for conveying people and a method for manufacturing a step unit.

There may be a need, among other things, for a weight-optimized, improved step element for a system for conveying people, as well as an improved die-casting tool for producing such an improved step element, in particular with a desired distribution of alloy components.

Such a need can be met by an improved step element for a system for conveying people, as well as an improved die-casting tool for producing such a step element, according to the main claims. Advantageous embodiments are defined in the dependent claims and described in the description.

According to a first aspect of the invention, a step element made of die-cast metal for a system for conveying people is proposed, wherein the step element has a rib structure on a tread surface and a corrugated structure on a rear side of the tread surface, wherein a corrugation trough of the corrugated structure is arranged opposite a tread rib of the rib structure, in particular in order to save metal material in the region of a rib foot of the tread rib. On at least a portion of the corrugated structure, an impression of a turbulence structure formed in a pressure die-casting tool for the step element is arranged for generating a turbulent flow during casting of the step element, wherein the impression protrudes from the corrugated structure and, following a contour of the corrugated structure, depicts the corrugated structure. The turbulence structure prevents the flow of the liquid metal within a die casting tool from becoming strongly directed, thus resulting in a segregation of the alloy (in particular the distribution of metal oxides within the molten metal).

As described above, the impression of the turbulence structure protrudes from the surface provided with the corrugated structure, but the impression height of this impression is lower than the level differences of the corrugated structure so that the impression is substantially designed following the corrugated structure. As a result, the corrugation troughs are not stiffened by the impression, and the elastic behavior of the tread surface with a turbulence structure corresponds substantially to the elastic behavior of a tread surface of the same dimensions without a turbulence structure.

According to a second aspect of the invention, a pressure die-casting tool for a step element of a system for conveying people is proposed, wherein a negative of a rib structure of a tread surface of the step element is formed in a mold cavity of the pressure die-casting tool and, opposite thereto in the mold cavity, a negative of a corrugated structure of a rear side of the tread surface corresponding to the rib structure is formed, wherein a negative of a corrugation trough of the corrugated structure is arranged opposite a negative of a tread rib of the rib structure, in particular in order to save material in the region of a rib foot of the tread rib. A turbulence structure for generating a turbulent flow during casting of the step element is arranged at least on a portion of the negative of the corrugated structure, wherein the turbulence structure consists of recesses in the pressure die-casting tool, and wherein the recesses, following a contour of the negative of the corrugated structure, represent the corrugated structure.

In the following, a basic idea for embodiments of the invention described herein will be explained in greater detail; this explanation is to be interpreted as merely a rough summary and not as limiting the invention:

An aluminum alloy generally has different alloy components. The alloy components influence the mechanical properties of a cast part cast from the aluminum alloy. For example, the tensile strength of the aluminum alloy can be significantly higher than the tensile strength of pure aluminum. Important alloy components can be oxides, in particular aluminum oxides. The oxides can accumulate on a surface of the cast part and form an oxide skin. Likewise, certain alloy components can brace a metal lattice of the solidified aluminum alloy. Due to the oxide skin and/or the bracing of the metal lattice, the cast part can have a high flexural rigidity.

During casting, a mold cavity of a casting mold is filled with melt from a sprue. Air contained in the mold cavity is displaced by the liquid melt. In die casting, the melt is “shot” at high speed and high pressure into the mold cavity of a metal die casting tool or into a die-casting mold. Despite the high speed, a directed laminar flow can develop in the melt, in particular along linear contours of the mold cavity. Due to the laminar flow, concentrations of alloy components in the melt can locally increase or locally decrease. For example, a locally increased oxide concentration can make the cast part so hard locally during solidification that it becomes brittle. A locally reduced concentration of an alloy component can, for example, make the cast part so soft locally during solidification that it deforms plastically under load.

Linear structures can be created in particular by ribs and/or grooves in the mold cavity. When the melt flows along the ribs and/or grooves when filling the mold cavity, the usually turbulent flow at the sprue can change into a laminar flow. Such linear structures can be present, for example, where efforts are made to make the wall thickness of the cast part as constant or as small as possible. Then, for example, ribs on one side of the cast part can be compensated by depressions on an opposite side of the cast part to avoid material accumulation at a rib foot of the rib. Such a design can save considerable amounts of material per cast part.

The approach presented here achieves a mixing of the alloy components of the melt even in the region of such linear structures. In this case, the flow of the melt is deliberately disturbed at least regionally during the casting process. For this purpose, a turbulence structure in the form of recesses in the linear structures is superimposed on the linear structures of the casting mold. At these recesses, turbulence is generated in the flow, and the formation of laminar flow is prevented, or turbulent flow is generated again. The recesses can be substantially sharp-edged in order to create local turbulence at the edges of the recesses. The recesses are filled by the melt during casting and form elevations on the cast part. These elevations on the cast part are therefore an impression of the turbulence structure.

The impression or its elevations on the cast part have no mechanical function, i.e. they do not influence the mechanical properties of the cast part, or at least not significantly. The elevations are small, in particular compared to the wall thickness of the cast part. For example, an impression height of the elevations can be less than 50%, less than 30% or even less than 15% of the wall thickness, where the wall thickness is to be understood as the average value of a wall thickness of the cast part over its entire extent or alternatively as the wall thickness in a region of the cast part directly adjacent to the elevation.

In order to achieve a consistently low impression height of the elevations and to avoid stress peaks in the elevations, a contour of the elevations or the impression is adapted to a contour of the linear structures. The elevations therefore follow the contour of the linear structures. Accordingly, an average impression height of the impression can be between 5% and 50% of a corrugation trough height. Preferably, the impression height of the impression is between 20 to 40% or particularly preferably between 25 to 35% of the corrugation trough height.

The approach presented here can avoid undesirable local concentrations of alloy components in, on, and/or after regions in which a laminar flow would conventionally develop during casting. By maintaining the desired mixing ratios or desired alloy composition, the mechanical properties of the cast part can be influenced in a targeted manner. By reliably achieving the mechanical properties, the cast part can be cast with reduced wall thicknesses and still have a high long-term load bearing capacity. Due to the reduced wall thicknesses, the cast part can have a low weight. Furthermore, the additional recesses can provide an enlarged surface between the pressure die-casting tool and the melt and achieve improved heat transfer from the melt into the pressure die-casting tool. This allows the solidification of the cast part to be accelerated and the production cycle time to be shortened. By preserving the underlying linear structures even at the superimposed turbulence structure, mechanical stiffening of the cast part can be avoided.

Possible embodiments and advantages of embodiments of the step elements and the pressure die-casting tool are described in more detail below.

Step elements of the aforementioned type are used in systems for conveying people that are designed as escalators or moving walkways. The system for conveying people has a circumferentially movable step belt made up of step elements arranged one behind the other and connected to one another in an articulated manner. The step belt provides a movable usable surface in a user-accessible region of the system for conveying people, which can be moved in circulating fashion between opposite access regions. A step element can be a step of the escalator or a pallet of the moving walkway. On the upper side of a step element, there is a tread surface of the step element. The usable surface is composed of the tread surfaces of a plurality of step elements. The tread surfaces of a moving walkway can form a substantially flat surface without any significant height difference. In an escalator, the tread surfaces in a sloping region of the escalator can each have a height offset from each other. A step of an escalator may have an arched front wall aligned transversely to the tread surface.

A rib structure made of tread ribs is arranged on the tread surface, i.e. on the upper side of the step element. The tread ribs are aligned in a transport direction of the system for conveying people so that they can mesh with the fixed comb structures of a comb plate arranged in access regions of the system for conveying people. The meshing of the rib structures can prevent objects from being drawn into a gap between the tread surface and the comb plate at the end of the system for conveying people. The tread ribs can be conical due to a draft angle, i.e. they become thicker towards a rib foot.

On a rear side of the tread surface, i.e. on an underside of the step element, there is arranged a corrugated structure of adjacent corrugation troughs and corrugation crests therebetween. The corrugation troughs are also aligned in the direction of transport and run parallel to the tread ribs. The corrugation troughs on the rear side can be arranged exactly below the tread ribs on the tread surface. In other words, the corrugation troughs can be arranged opposite the tread ribs of the rib structure. Each tread rib can be assigned a corrugation trough, and in each case, the corrugation trough can run at the shortest possible distance from the associated tread rib. The corrugation troughs prevent material from accumulating at the rib foot below the tread ribs. Providing the corrugation troughs can therefore save material. In particular, the provision of the corrugation troughs can contribute to a material thickness remaining largely the same at different points along the step element, i.e., varying for example by less than 50%, preferably less than 30% or less than 10%.

The step element can be formed as a die-cast component by die casting in a mold or in a pressure die-casting tool. The mold can substantially be filled with melt from one side to the other side to avoid air inclusions. During filling, the melt flows rapidly along a contour of a mold cavity of the mold. Since the rib structure and the corrugated structure are substantially linear structures and influence the flow direction of the melt during casting, the melt can change into a laminar flow at these linear structures.

In the approach presented here, a turbulence structure is incorporated at least in parts of the linear structures, in particular the corrugated structure, in order to prevent the flow from becoming laminar. The turbulence structure can consist, for example, of sharp-edged recesses in the contour of the mold.

As the melt flows past the turbulent structure, eddies or turbulences are generated at the edges of the turbulent structure. The turbulence causes a change from a laminar flow that may be present into a turbulent flow. Compared to the laminar flow, the turbulent flow reduces the boundary layer at the contour and achieves a more uniform velocity distribution in the melt. At least one of these effects leads to increased mixing of the melt compared to the laminar flow and thus to a more uniform distribution of alloy components in the melt.

The turbulence structure in the pressure die-casting tool can have a depth which is small compared to the structures that are provided for forming the rib structure and/or the corrugation troughs, in particular less than 50%, less than 40% or even less than 10% of their depth. Accordingly, the impression that arises on the rear side of the step element during casting due to the turbulence structure embedded in the pressure die-casting tool can have a small impression height compared to the height dimensions of the rib structure and/or the trough height of the corrugated structure. Due to this low impression height, the impression does not influence the mechanical properties of the step element, or at most does so only insignificantly.

The turbulence structure can have a substantially constant depth because the turbulence effect does not increase with depth. In other words, the recesses in the pressure die-casting tool that form the turbulence structure represent, or at least substantially represent, a contour of the negative of the corrugated structure. In other words, a depth by which the turbulence structure protrudes from a surface of the mold cavity into the pressure die-casting tool can be substantially constant in all regions of the mold cavity, in particular also along the depressions of the negative of the corrugated structure. This accordingly causes the resulting impression to protrude from the corrugated structure and substantially depict a contour of the corrugated structure, or in other words, to protrude above the surface in lower regions of the corrugated structure substantially to the same extent as in higher regions of the same, or in regions between adjacent corrugation troughs.

Due to the substantially uniform depth of the turbulence structure, any influence on the mechanical properties of the step element, for example due to stiffening by the impressions of the turbulence structure, can be kept very low. In particular, this can prevent mechanical overloading of the impressions when the step element is bent.

The turbulence structure can also be arranged on the rear side of the front wall.

The turbulence structure can, for example, have similar dents as recesses in the contour of the corrugated structure, which are uniformly distributed over the surface. The recesses can also be elongated. The recesses can be arranged offset from one another. In particular, edges of the turbulence structure aligned transversely to a flow direction can be substantially sharp-edged, wherein the flow direction refers to a melt flowing through the mold cavity of the pressure die-casting tool during casting of the step element.

The impression of the turbulence structure generally has a shape complementary to the turbulence structure and accordingly protrudes beyond a surrounding surface of the step element. The impression of the turbulence structure can consist of fine ribs that protrude from the corrugated structure. The fine ribs can be narrow and low. The fine ribs can be substantially sharp-edged or can merely have broken edges. In particular, a minimum radius of curvature at protruding edges of the impression or the fine ribs can be considerably smaller than minimum radii of curvature, for example, at the rib structure and/or the corrugated structure.

Recesses for the turbulence structure or, in particular, for the fine ribs can be integrated into the contour of the mold with little manufacturing effort. For example, the recesses can be milled into the contour controlled by a program. At least in the portions, the fine ribs can be made with the impression of the turbulence structure, continuously and following the corrugated structure.

The fine ribs can be aligned in different directions. In particular, a first group of fine ribs can extend in a first direction along the rear side of the step element, and a second group of fine ribs can extend in a second direction along the rear side of the step element. The first and the second direction can be oriented transversely to each other.

The fine ribs can be connected to each other at node points. Between the fine ribs, there can be pockets enclosed by the fine ribs. The pockets can be arranged regularly on the rear side. The pockets can have simple geometric shapes. For example, the pockets can be diamond-shaped, square, honeycomb-shaped or triangular. Alternatively, the fine ribs can also be interrupted. In this way, node points and consequently material accumulations at the node points can be avoided.

The fine ribs can be oriented in only two different directions, i.e. a first group of fine ribs can run in a first direction, and a second group of fine ribs can run in a second direction. The pockets can then be square. The pockets can be distributed waffle-like over the portions. Recesses for fine ribs in only two directions can be quickly and cost-effectively introduced into the mold.

The node points can be arranged at regular spacings. Spacings of node points can be different from spacings of corrugation troughs. The node points can be arranged irregularly across the corrugated structure. The turbulence structure can therefore have a different division/grid than the corrugated structure. The node points at different corrugation troughs can then have different relative positions to the corrugation troughs. By using different divisions/grids, harmonic oscillations caused by the resulting turbulence can be avoided. Alternatively, the turbulence structure can have the same division/grid as the corrugated structure. Node points of the fine ribs can then be arranged at the same relative positions to the corrugation troughs.

The recesses for the fine ribs can be aligned at an angle transverse to a flow direction during casting or transverse to the corrugation troughs. In particular, the recesses can be aligned at greater than 45° to the flow direction or the corrugation troughs. By obliquely positioning the recesses, an increased mixing effect of the melt is achieved.

The impression height of the fine ribs above the contour of the corrugated structure can be approximately constant. The fine ribs are adapted to the contour of the corrugated structure or can follow the contour of the corrugated structure. The fine ribs have an elevation if the contour of the corrugated structure has an elevation. The fine ribs have a depression if the contour of the corrugated structure has a depression. Given a constant impression height, bending stress peaks at higher points of the fine ribs can be avoided.

The fine ribs on the step element or the recesses for the fine ribs in the pressure die-casting tool or in the mold can have a triangular cross-sectional surface, at least outside the corrugation troughs. The fine ribs can therefore have a sharp-edged rear side. Recesses with a triangular cross-sectional surface can have a small volume and increase the total volume of the mold cavity only insignificantly.

The impression of the turbulence structure can be interrupted by at least one smooth ejector surface. The corrugated structure can also be interrupted by the ejector surface. An ejector of the mold can rest on the ejector surface of the cast part. To remove the cast part from the mold, the mold can be opened. The mold slides can be retracted and the ejectors can extend, press against the cast part, and push the cast part out of the mold contour. The ejectors can be round or circular and require corresponding ejector surfaces on the cast part. The ejector surfaces can be large to avoid deformation of the cast part during ejection. In the case of circular ejector surfaces, the turbulence structure can continue in the inner circle. By interrupting the corrugated structure in the region of the ejector surface, the cast part can have increased rigidity there in order to avoid deformation during ejection.

The step element can also have impressions of turbulence structures on at least portions of side walls of the step element to generate a turbulent flow during casting. The impressions on the side walls can have a different or the same division as the impressions on the corrugated structure. The impressions of the turbulence structure on the side walls can be arranged on an outer side of the side walls. An inside of the side walls can be smooth. The impressions can be formed onto the side walls by a turbulence structure on the side sliders of the mold. The sliders are pulled back to eject the step element and thereby expose undercuts in the side walls. On the inside, the mold can be designed without a slider.

It should be noted that some of the possible features and advantages of the invention are described herein with reference to different embodiments of methods on the one hand and of devices on the other. A person skilled in the art will recognize that the features can be suitably combined, adapted, or exchanged in order to arrive at further embodiments of the invention.

Embodiments of the invention will be described below with reference to the accompanying drawings, wherein neither the drawings nor the description are intended to be interpreted as limiting the invention.

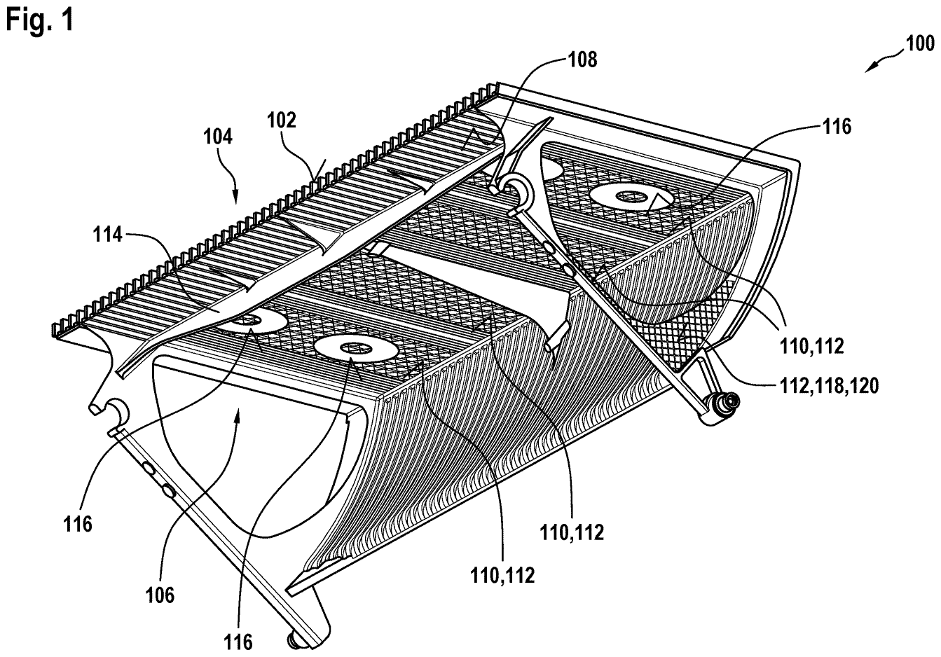

FIG. 1 shows a representation of a step element according to an exemplary embodiment; and

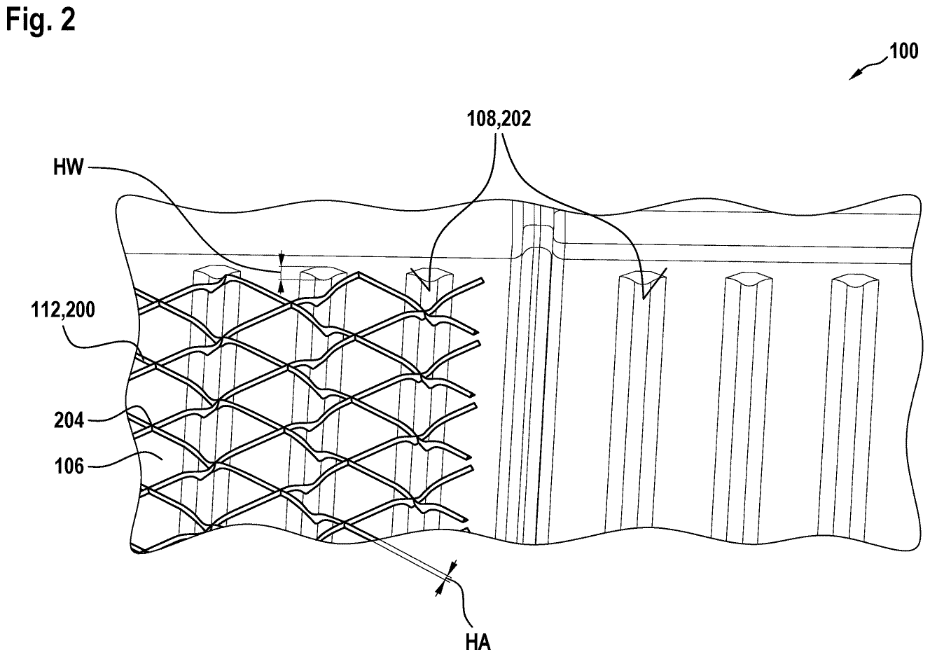

FIG. 2 shows a representation of a turbulence structure on a rear side of a step element according to an embodiment.

The figures are merely schematic and not true to scale. The same reference signs indicate the same or equivalent features.

FIG. 1 shows a representation of a step element 100 for a system for conveying people. The system for conveying people can be an escalator or moving walkway. The step element 100 here is a step of an escalator, but can also be for example a pallet of a moving walkway. The step element 100 is a die-cast part. The step element 100 has a tread surface 102 on an upper side. Persons being conveyed can stand with their feet on the tread surface 102.

On an upper side of the tread surface 102, the step element 100 has a rib structure 104 made of tread ribs. On a rear side 106 of the tread surface 102, the step element 100 has a corrugated structure 108 consisting of corrugation troughs 202 (see also FIG. 2) corresponding to the rib structure 104. The tread ribs and the corrugation troughs 202 are aligned with each other and arranged exactly opposite each other on the tread surface 102 and the rear side 106. The corrugated structure 108 prevents material accumulation on rib feet of the tread ribs. As a result, the tread surface 102 has a more uniform wall thickness than without the corrugated structure 108.

In portions 110, impressions 112 of a turbulence structure for generating turbulence during casting are superimposed on the corrugated structure 108. The turbulence structure is an auxiliary structure for the production of the step element 100 by a die-casting process. During production, a molten metal alloy or a melt, in particular of an aluminum alloy, is introduced into a pressure die-casting tool and solidifies in a mold cavity of the pressure die-casting tool. The pressure die-casting tool is made of metal and can be called a mold. The melt fills the mold cavity starting from a sprue of the mold and forms a contour of the mold cavity. The melt then cools in the mold cavity and solidifies to form the die-cast part. The solidified die-cast part then has an inverse contour of the mold cavity. The mold cavity therefore forms a negative shape of the die-cast part.

A surface of the mold cavity is substantially smooth or has a slight roughness. On the smooth surface and in particular on linear structures of the mold cavity, such as the rib structure 104 and the corrugated structure 108, the melt can change into a laminar flow when filling the mold cavity. Due to the laminar flow, alloy components in the melt can be distributed unevenly, or local concentration differences of the alloy components can develop. This may be undesirable.

The turbulence structure improves the mixing of the alloy components of the melt during filling of the mold cavity by causing or restoring a turbulent flow at least in the region of the portions 110. The impressions 112 of the turbulence structure on the step element 100 arise by molding the turbulence structure of the pressure die-casting tool.

In one embodiment, the impressions 112 of the turbulence structure extend from a front edge of the step element 100 to a main stiffening rib 114 on the rear side 106. Due to the turbulence structure, the melt enters a cavity of the pressure die casting tool for the main stiffening rib 114 highly mixed. This avoids local concentrations of individual alloy components in the melt. In particular, locally increased concentrations of oxides in the region of the main stiffening rib 114 can be avoided. These locally elevated concentrations would locally increase a stiffness of the main stiffening rib 114 and locally make brittle the main stiffening rib 114. Due to the good mixing from the turbulence structure, a largely homogeneous mixing of the alloy components can be achieved in the main stiffening rib 114. The main stiffening rib 114 can therefore be designed with a small wall thickness of, for example, 1.4 millimeters since the main stiffening rib 114 can be designed with reduced load reserves. In other words, the turbulence structure not only directly affects the surfaces covered with the impressions 112, but in particular also on adjacent regions of the step element 100 such as the main stiffening rib 114 which has no impressions.

In one embodiment, the step element 100 has four separate portions 110 with impressions 112 of the turbulence structure. The portions 110 are arranged at a distance from one another between the leading edge and the main stiffening rib 114.

In one embodiment, ejector surfaces 116 for ejectors of the pressure die-casting tool are arranged in the at least one portion 110. The ejector surfaces 116 here are large circular rings without a corrugated structure 108 and without impressions 112 of the turbulence structure. The corrugated structure 108 and the impressions 112 of the turbulence structure continue in the inner circles of the ejector surfaces 116. The turbulent flow does not change into a laminar flow in the region of the ejector surfaces 116. The ejector surfaces 116 therefore do not substantially reduce the mixing when filling the mold cavity. In addition, the ejector surfaces 116 are surrounded on all sides by the impressions 112 of the turbulence structure so that the melt flowing on from the regions of the ejector surfaces 116 is again made turbulent.

In one embodiment, further impressions 112 of turbulence structures of the pressure die-casting tool are arranged at least on portions 110 of side surfaces 118 of side walls 120 of the step element 100. The turbulence structures also improve the mixing of the melt during casting on the side walls 120 and prevent undesirable concentrations of certain alloy components.

FIG. 2 shows a representation of impressions 112 of a turbulence structure on the corrugated structure 108 of a step element 100 according to an embodiment. The step element 100 here substantially corresponds to the step element in FIG. 1. Here, a part of a portion 110 is shown in detail.

The impressions 112 consist of low, fine ribs 200 that protrude from the corrugated structure 108. The fine ribs 200 are arranged here at approximately 45° transversely to the corrugation troughs 202 of the corrugated structure 108, or to a direction of flow when filling the mold cavity. The fine ribs 200 are formed in the mold cavity as grooves in the contour of the mold cavity. At the edges of the grooves, turbulence is caused in the melt at each groove. This causes the melt to be set into turbulent flow and strongly mixed. The grooves or the fine ribs 200 are low compared to other stiffening components of the contour and do not fulfill any essential mechanical function on the step element 100.

In order to consistently achieve a low impression height of the fine ribs 200 or elevations and to avoid stress peaks in the ribs 200, a contour of the fine ribs 200 is adapted to a contour of the corrugated structure 108. The fine ribs 200 thus follow the contour of the corrugated structure 108. Accordingly, an average impression height HA of the impressions 112 is between 5% and 50% of a corrugation trough height HW of the corrugation trough 202. Preferably, the impression height HA of the impression 112 is between 20 to 40% or particularly preferably between 25 to 35% of the trough height HW.

In one embodiment, the impressions 112 consist of groups of fine ribs 200 crossing in two opposite directions. The fine ribs 200 are connected to each other at node points 204.

In one embodiment, the fine ribs 200 have uniform spacings. In this case, the spacings are selected such that the node points 204 are arranged in different relative positions to the corrugation troughs 202 of the corrugated structure 108.

In one embodiment, an upper edge of the fine ribs 200 or a rib head of the fine ribs 200 exactly follows the contour of the underlying corrugated structure 108. As a result, the fine ribs 200 are always the same height and also have depressions in the region of the corrugation troughs 202. This reduces mechanical stress on the fine ribs 200 in the region of the corrugation troughs 202 when the step element 100 is bent.

In the following, possible embodiments of the invention are summarized again or presented using slightly different wording.

A step with a waffle-like rib structure on the underside of the step tread surface is presented.

This waffle-like rib structure is advantageous here in order to optimize a corrugated structure of grooves on the underside of the step in the region of the tread surface webs, to reduce weight below the tread surface. Without a waffle-like rib structure, local aluminum oxide concentrations could occur, above all in the central region of the large stiffening rib, which would lead to a structural weakening of the aluminum die-cast step. The waffle-like rib structure therefore mainly serves to make the melt turbulent during the die-casting process. The fine ribs of the waffle-like rib structure follow the surface of the corrugated structure. This leads to the prevention of crack formation starting from rib tips by adapting to the corrugated structure. The following fine ribs result in a consistently high elasticity and an avoidance of stress concentrations. Under load, in the region of the corrugation troughs 202 if the ribs are routed straight, high bending stress concentrations could occur in the outermost fibers of the fine ribs due to the bending. In addition, the following fine ribs further save some material, which saves considerable material costs when large quantities are produced.

The waffle-like rib structure can be arranged over the entire underside. The waffle-like rib structure can also be arranged on only part of the underside. The surface with the corrugated structure and the rib structures can have flat regions. The flat regions can for example be ring surfaces for ejectors. Due to their limited extent, the flat regions hardly affect the turbulent flow.

A waffle-like rib structure can also be arranged on the side surfaces of the side walls. The edge region on the right and/or left can be designed with a recess. The step element can be designed as a one-piece die-cast aluminum part. Alternatively, the step element can be made up of multiple pieces.

Finally, it should be noted that terms such as “having,” “comprising,” etc. do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1. A step element for a system for conveying people,
wherein the step element has a rib structure on a tread surface made of die-cast metal and a corrugated structure on a rear side of the tread surface,
wherein a corrugation trough of the corrugated structure is arranged opposite a tread rib of the rib structure,
wherein on at least one portion of the corrugated structure, an impression of a turbulence structure is arranged, the impression being formed in a pressure die-casting tool for the step element for generating a turbulent flow when casting the step element,
wherein the impression projects from the corrugated structure and, following a contour of the corrugated structure, represents the corrugated structure, and
wherein an average impression height (HA) of the impression is between 5% and 50% of a corrugation trough height (HW) of the corrugation trough.

2. The step element according to claim 1, wherein the average impression height (HA) of the impression is between 20% and 40% of the corrugation trough height (HW) of the corrugation trough.

3. The step element according to claim 1, wherein the impression comprises fine ribs that are continuous, wherein the fine ribs have a triangular cross-section at least outside the corrugation troughs.

4. The step element according to claim 3, wherein the fine ribs are aligned in different directions and are connected to one another at node points, wherein pockets enclosed by the fine ribs are arranged between the fine ribs.

5. The step element according to claim 4, wherein the node points are spaced apart in regular intervals, wherein the intervals between the node points are different from the intervals between the corrugation troughs.

6. The step element according to claim 3, wherein the fine ribs are oriented at a transverse angle to the corrugation troughs.

7. The step element according to claim 3, wherein an impression height (HA) of the fine ribs is substantially constant above the contour of the corrugated structure.

8. (canceled)

9. The step element according to claim 1, wherein the impression is interrupted by at least one ejector surface.

10. The step element according to claim 3, wherein the impressions of turbulence structures of the pressure die-casting tool are also included at least on portions of side walls of the step element.

11. A pressure die-casting tool for a step element of a system for conveying people,
wherein a negative of a rib structure of a tread surface of the step element is formed in a mold cavity of the pressure die-casting tool and, opposite to the negative of the rib structure in the mold cavity, a negative of a corrugated structure of a rear side of the tread surface is formed, corresponding to the rib structure,
wherein a negative of a corrugation trough of the corrugated structure is in each case arranged opposite a negative of a tread rib of the rib structure,
wherein a turbulence structure for generating a turbulent flow while casting the step element is arranged at least on a portion of the negative of the corrugated structure,
wherein the turbulence structure comprises recesses in the pressure die-casting tool,
wherein the recesses, following a contour of the negative of the corrugated structure, represent the corrugated structure, and
wherein an average impression height (HA) of an impression that can be produced by the recesses is between 5% and 50% of a corrugation trough height (HW) of the trough.

12. The pressure die-casting tool according to claim 11, wherein the average impression height (HA) of the impression that can be produced by the recesses is between 20 and 40% of the corrugation trough height (HW) of the corrugation trough.

13. The pressure die-casting tool according to claim 11, wherein the average impression height (HA) of the impression that can be produced by the recesses is between 25% and 35% of the corrugation trough height (HW) of the corrugation trough.

14. The step element according to claim 1, wherein the average impression height (HA) of the impression is between 25% and 35% of the corrugation trough height (HW) of the corrugation trough.
